(19) United States
(12) Patent Application Publication
(10) Pub. No.: US 2023/0376559 A1
(43) Pub. Date: Nov. 23, 2023

(54) SOLUTION METHOD SELECTION DEVICE AND METHOD

(71) Applicant: NEC Corporation, Minato-ku, Tokyo (JP)

(72) Inventors: Yuki KOBAYASHI, Tokyo (JP); Fumiyo Takano, Tokyo (JP); Hiroaki Inoue, Tokyo (JP); Takuya Araki, Tokyo (JP); Motol Suzuki, Tokyo (JP); Takahiro Nishimura, Tokyo (JP); Hiroshi Chishima, Tokyo (JP); Akihiro Yatabe, Tokyo (JP)

(73) Assignee: NEC Corporation, Minato-ku, Tokyo (JP)

(21) Appl. No.: 18/027,280

(22) PCT Filed: Nov. 2, 2020
(86) PCT No.: PCT/JP2020/041055

§ 371 Date: Mar. 20, 2023

(51) Int. Cl. G06F 17/11

(52) U.S. Cl. CPC G06F 17/11

(57) ABSTRACT

The feature information derivation means 72 derives feature information that represents a feature of a model used to solve a combinatorial optimization problem, when the model is given. The solution method selection means 73 selects a solution method for the combinatorial optimization problem from among predetermined multiple types of solution methods based on the feature information. The solution request means 74 send a solution request that includes information that can specify the model used to solve the combinatorial optimization problem to a solution device that solves the combinatorial optimization problem using the selected solution method.

### TECHNICAL FIELD

The present invention relates to a solution method selection device, a solution method selection method, and a computer-readable recording medium in which a solution method selection program is recorded, for selecting a solution method for a combinatorial optimization problem.

### BACKGROUND ART

In recent years, various techniques have been proposed to solve combinatorial optimization problems by quantum annealing, simulated annealing, and other methods.

For example, PTL 1 describes a computation system that uses quantum devices to find solutions to combinatorial optimization problems.

In addition, PTL 2 describes a semiconductor device that can reduce the cost of the device and can find solutions to combinatorial optimization problems.

NPL 1 also describes a system that uses parametric oscillators to find solutions to combinatorial optimization problems represented by the Ising model.

In addition, PTL 3 describes a device that can efficiently find solutions to combinatorial optimization problems.

In addition, PTL 4 describes a calculation device that uses an equation-of-motion-based algorithm to find a solution to a combinatorial optimization problem.

In addition, PTL 5 describes a technique for determining an arithmetic unit according to the scale of the combinatorial optimization problem or the required accuracy, and having that the arithmetic unit perform the arithmetic for the combinatorial optimization problem.

In general, when solving a combinatorial optimization problem, an expression representing energy in the combinatorial optimization problem is first created. For example, when solving a traveling salesman problem, an expression representing the energy in the traveling salesman problem is created. Then, the expression representing the energy in the combinatorial optimization problem is converted to an energy function of the Ising model or QUBO (Quadratic Unconstrained Binary Optimization).

The Ising model is a model in statistical mechanics that represents the behavior of a magnetic material by individual spins, and it is also applicable to solving combinatorial optimization problems. In the Ising model, the states of individual spins are represented by “1” or “−1”.

QUBO is a model in which the states of individual spins are represented by “1” or “0”.

The energy function of the Ising model is expressed as the following Expression (1).

[Math. 1]

H_{Ising}=ΣᵢⱼJᵢⱼSᵢSⱼΣᵢhᵢsᵢ (1)

The left side of Expression (1) represents energy. Both i and j in Expression (1) are variables representing spin numbers. When the number of spins is N, i∈1, 2, . . . , N, and similarly, j∈1, 2, . . . , N. Also, s, in Expression (1) is a variable that represents the state of spin i, and sⱼ is a variable that represents the state of spin j. In the Ising model, the states of the individual spins are “1” or “−1”. Jᵢⱼ in Expression (1) is a constant corresponding to a combination of spin i and spin j. For each combination of a possible value of i and a possible value of j, Jᵢⱼ is defined as a constant. There are N² constants Jᵢⱼ when the number of spins is N. The set of constants Jᵢⱼ is represented by a matrix of N rows and N columns. That is, the constant Jᵢⱼ corresponding to a combination of two spins is an element of the matrix of N rows and N columns. Hereafter, the matrix with N² constants Jᵢⱼ as elements is referred to as the matrix J. hᵢ in Expression (1) is a constant corresponding to spin i. For each possible value of i, hᵢ is defined as a constant.

There are N constants hᵢ in Expression (1) when the number of spins is N. The set of constants hᵢ is represented by a vector with N elements. Hereafter, this vector is referred to as the vector H. The matrix J and the vector H are information that can specify the Ising model expressed in Expression (1).

The energy function of QUBO is expressed as the following Expression (2).

[Math. 2]

H_{QUBO}=ΣᵢⱼQᵢⱼxᵢxⱼ (2)

The left side of Expression (2) represents energy. Both i and j in Expression (2) are variables representing spin numbers. When the number of spins is N, i∈1, 2, . . . , N, and similarly, j∈1, 2, . . . , N. In addition, xᵢ in Expression (2) is a variable that represents the state of spin i, and xⱼ is a variable that represents the state of spin j. In QUBO, the states of the individual spins are “1” or “0”. Qᵢⱼ in Expression (2) is a constant corresponding to a combination of spin i and spin j. For each combination of a possible value of i and a possible value of j, Qᵢⱼ is defined as a constant. There are N² constants Qᵢⱼ when the number of spins is N. The set of constants Qᵢⱼ is represented by a matrix of N rows and N columns. That is, the constant Qᵢⱼ corresponding to a combination of two spins is an element of the matrix of N rows and N columns. Hereafter, the matrix with N² constants Qᵢⱼ as elements is referred to as the matrix Q. The matrix Q is information that can specify QUBO expressed in Expression (2).

Expression (1) and Expression (2) are mutually convertible. That is, the energy function of the Ising model can be converted to the energy function of QUBO, and similarly, the energy function of QUBO can be converted to the energy function of the Ising model. This conversion method is known.

Both the Ising model and QUBO are models used to solve combinatorial optimization problems.

In quantum annealing and simulated annealing, the states of spins that minimize the energy function of the Ising model or QUBO are found as a solution to a combinatorial optimization problem.

### CITATION LIST

### Patent Literature

PTL 1: Japanese Patent Application Laid-Open No. 2008-525873

PTL 2: Japanese Patent No. 5851570

PTL 3: Japanese Patent No. 6465092

PTL 4: Japanese Patent Application Laid-Open No. 2019-145010

PTL 5: Japanese Patent Application Laid-Open No. 2020-46996

### Non Patent Literature

NPL 1: Yoshitaka Haribara, et al., “Performance evaluation of coherent Ising machines against classical neural networks”, Quantum Sci. Technol. 2, 044002 (2017).

### SUMMARY OF INVENTION

### Technical Problem

As mentioned above, various techniques have been proposed to solve combinatorial optimization problems by quantum annealing, simulated annealing, and other methods.

For various solution methods for combinatorial optimization problems, it is considered that there is a combinatorial optimization problem that can be solved efficiently by the solution method. For example, the technique described in NPL 1 and the technique described in PTL 4 are considered to be able to solve the maximum cut problem at high speed. In addition, the technique described in PTL 2 and the technique described in PTL 3 are considered to be able to efficiently solve the traveling salesman problem.

However, even though multiple solution methods exist, when an Ising model expressed in Expression (1) or QUBO expressed in Expression (2) is given to an information processing equipment, it is difficult for the information processing equipment to appropriately select a solution method suitable for the given model from among the multiple solution methods. This is because it is unknown to the information processing equipment what kind of combinatorial optimization problem the given model is derived from.

As mentioned above, PTL 5 describes a technique for determining an arithmetic unit according to the scale of the combinatorial optimization problem or the required accuracy, and having that arithmetic unit execute the combinatorial optimization problem. However, even with the technology described in PTL 5, it was difficult to appropriately select a solution method suitable for a given model from among multiple solution methods. For example, it is assumed that a solution to the traveling salesman problem is obtained using the technology described in PTL 5. The technique described in PTL 5 only determines an arithmetic unit according to the scale of the combinatorial optimization problem or the required accuracy, so the determined arithmetic unit is not necessarily suitable for solving the traveling salesman problem. Therefore, it cannot be said that the technique described in PTL 5 selects a solution method suitable for a given model.

Therefore, an object of the present invention is to provide a solution method selection device, a solution method selection method, and a computer-readable recording medium in which a solution method selection program is recorded that, given a model used for solving a combinatorial optimization problem, can select a solution method suitable for the given model from among predetermined multiple types of solution methods.

### Solution to Problem

A solution method selection device according to the present invention includes: feature information derivation means for deriving feature information that represents a feature of a model used to solve a combinatorial optimization problem, when the model is given; solution method selection means for selecting a solution method for the combinatorial optimization problem from among predetermined multiple types of solution methods based on the feature information; and solution request means for sending a solution request that includes information that can specify the model used to solve the combinatorial optimization problem to a solution device that solves the combinatorial optimization problem using the selected solution method.

A solution method selection method according to the present invention is implemented by a computer, and comprises: deriving feature information that represents a feature of a model used to solve a combinatorial optimization problem, when the model is given; selecting a solution method for the combinatorial optimization problem from among predetermined multiple types of solution methods based on the feature information; and sending a solution request that includes information that can specify the model used to solve the combinatorial optimization problem to a solution device that solves the combinatorial optimization problem using the selected solution method.

A computer-readable recording medium according to the present invention is a computer-readable recording medium in which a solution method selection program is recorded, wherein the solution method selection program causes a computer to execute: a feature information derivation process of deriving feature information that represents a feature of a model used to solve a combinatorial optimization problem, when the model is given; a solution method selection process of selecting a solution method for the combinatorial optimization problem from among predetermined multiple types of solution methods based on the feature information; and a solution request process of sending a solution request that includes information that can specify the model used to solve the combinatorial optimization problem to a solution device that solves the combinatorial optimization problem using the selected solution method.

### Advantageous Effects of Invention

According to the present invention, given a model used for solving a combinatorial optimization problem, a solution method suitable for the given model can be selected from among predetermined multiple types of solution methods.

### BRIEF DESCRIPTION OF DRAWINGS

FIG. 1 It depicts a block diagram showing an example configuration of a solution method selection device of the example embodiment of the present invention.

FIG. 2 It depicts a schematic diagram showing each category of the degree of connection between spins and the solution method corresponding to each category.

FIG. 3 It depicts a schematic diagram showing an example of a case in which there is a category to which multiple methods of solution solutions are corresponded.

FIG. 4 It depicts a schematic diagram showing an example of the matrix J and the vector H of the Ising model obtained based on the maximum cut problem.

FIG. 5 It depicts a schematic diagram showing the connection between spins corresponding to FIG. 4.

FIG. 6 It depicts a schematic diagram showing an example of the matrix J and the vector H of the Ising model obtained based on the traveling salesman problem.

FIG. 7 It depicts a schematic diagram showing the connection between spins corresponding to FIG. 6.

FIG. 8 It depicts a sequence diagram showing an example of the processing flow of the solution method selection device of the example embodiment of the present invention.

FIG. 9 It depicts a schematic diagram showing an example of information in which a solution method is corresponded to a combination of the category of the number of spins and the category of the degree of connection between spins.

FIG. 10 It depicts an explanatory diagram showing an example of the degree of connection between spins and the number of spins derived in step S1.

FIG. 11 It depicts a schematic diagram showing an example of the selected solution method information.

FIG. 12 It depicts a schematic diagram showing an example of a solution request.

FIG. 13 It depicts a schematic block diagram showing an example of computer configuration related to the solution method selection device of the example embodiment of the present invention.

FIG. 14 It depicts a block diagram showing an overview of the solution method selection device of the present invention.

### DESCRIPTION OF EMBODIMENTS

An example embodiment of the present invention is described below with reference to the drawings.

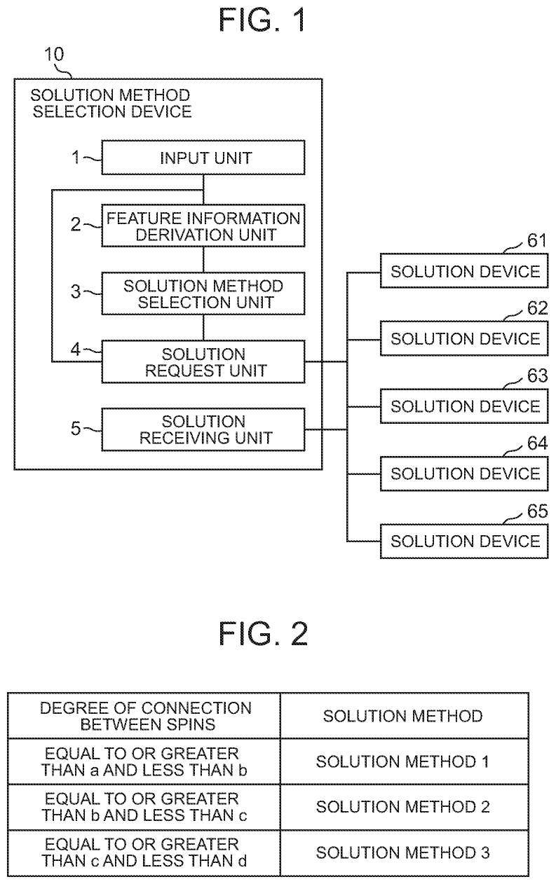

FIG. 1 is a block diagram showing an example configuration of a solution method selection device of the example embodiment of the present invention. The solution method selection device 10 of the present example embodiment includes an input unit 1, a feature information derivation unit 2, a solution method selection unit 3, a solution request unit 4, and a solution receiving unit 5.

The solution method selection device 10 is communicatively connected to multiple solution devices 61-65. Although FIG. 1 shows an example of five solution devices 61-65, the number of solution devices is not limited to five, and there need only be multiple solution devices.

Each of the solution devices 61-65 uses a different solution method to solve a combinatorial optimization problem. In other words, the solution method for the combinatorial optimization problem is different for each of the solution devices 61-65.

When the solution devices 61-65 receive a solution request that includes information that can specify the Ising model (see Expression (1)) or QUBO (see Expression (2)) from the solution method selection device 10 (specifically, the solution request unit 4), they specify the Ising model or QUBO from the information and solve the combinatorial optimization problem based on the Ising model or QUBO. The above solution request may also include parameters to be used in solving the combinatorial optimization problem, in addition to the information that can specify the Ising model or QUBO.

When the solution to the combinatorial optimization problem is obtained, the solution is sent from the solution devices 61-65 to the solution method selection device 10 (specifically, the solution receiving unit 5).

The solution devices 61-65, which solve combinatorial optimization problems using different solution methods, may be realized on the same computer as the solution method selection device 10.

The Ising model (the energy function expressed in Expression (1)) or QUBO (the energy function expressed in Expression (2)) is input to the input unit 1.

The input unit 1 may be an input device such as, for example, a keyboard. Alternatively, the input unit 1 may be realized by a data reading device that reads the Ising model or QUBO recorded on a data recording medium such as an optical disk, for example.

The following explanation uses the case where an Ising model is input to input unit 1 as an example, but QUBO may also be input to input unit 1. When QUBO is input to input unit 1, the matrix Q is used instead of the matrix J in the feature information derivation process described below. The matrix J and the matrix Q have already been explained, so their explanation is omitted here.

When a model (the Ising model or QUBO) used to solve a combinatorial optimization problem is input to input unit 1, the feature information derivation unit 2 derives feature information that represents the feature of the model. As mentioned above, the case in which the Ising model is input to input unit 1 will be used here as an example.

For example, “the degree of connection between spins”, “the statistic of the elements of the matrix J”, and “the eigenvalue of the matrix J” are examples of the feature information that represents the feature of the Ising model. The “degree of connection between spins”, “the statistic of the elements of the matrix J”, and “the eigenvalue of the matrix J” are all irrelevant to the scale of the combinatorial optimization problem and the required accuracy.

The “degree of connection between spins”, “the statistic of the elements of the matrix J”, and “the eigenvalue of the matrix J” are examples of the feature information, and the feature information derivation unit 2 may derive other information as the feature information representing the feature of the Ising model. However, the feature information of the model is information that is irrelevant to the scale of the combinatorial optimization problem and the required accuracy.

The feature information derivation unit 2 may calculate one type of feature information or two or more types of feature information.

The “degree of connection between spins” is the average of how many of the other spins are connected to a given spin. It is assumed the number of spins specified from the input model (in this case, the Ising model) is N. Also, it is assumed that the number of non-zero value elements in the matrix J is Z. In this case, the degree of connection between spins is obtained by calculating Z/((N−1)*N). In other words, the feature information derivation unit 2 can derive the degree of connection between spins by calculating Z/((N−1)*N). When “%” is used as the unit of the degree of connection between spins, the feature information derivation unit 2 may derive the degree of connection between spins by calculating (Z/((N−1)*N))*100.

Examples of “the statistic of the elements of the matrix J” include an average, variance, or a standard deviation of the elements of the matrix J. The statistic of the elements of the matrix J is not limited to the average, the variance, or the standard deviation, but may be, for example, a scalar quantity obtained from a histogram of the elements of the matrix J (e.g., the ratio of the number of elements with a value between 0.1 and 0.5 to the total number of elements of the matrix J).

The feature information derivation unit 2 obtains feature information such as “the degree of connection between spins”, “the statistic of the elements of the matrix J”, “the eigenvalue of the matrix J”, etc., as scalar quantities.

If QUBO is input as the model, the matrix Q is used instead of the above matrix J.

Depending on the type of combinatorial optimization problem, the tendency of feature information varies.

The solution method selection unit 3 selects a solution method for the combinatorial optimization problem that is the basis of the input Ising model from among predetermined multiple types of solution methods based on the feature information derived by the feature information derivation unit 2. The predetermined multiple types of solution methods are the respective solution methods corresponding to each solution device (in the example shown in FIG. 1, the solution devices 61-65).

For example, it is assumed that there are two predetermined multiple types of solution methods: “Solution Method 1” and “Solution Method 2”. The solution method selection unit 3 may, for example, select the “Solution Method 1” when the feature information (scalar quantity) is equal to or greater than a predetermined threshold value, and select the “Solution Method 2” when the feature information (scalar quantity) is less than the threshold value. However, the above example is only one example of how to select a solution method, and selection methods are not limited to the above example. Other selection methods are described below.

First, for the sake of simplicity, it is assumed that the solution method selection unit 3 selects a solution method based on one type of feature information (in this case, the degree of connection between spins). In this case, each category of the degree of connection between spins and a solution method corresponding to each category are predetermined. The solution method selection unit 3 retains this information in advance. The solution method selection unit 3 can select the solution method corresponding to the category to which the derived feature information belongs.

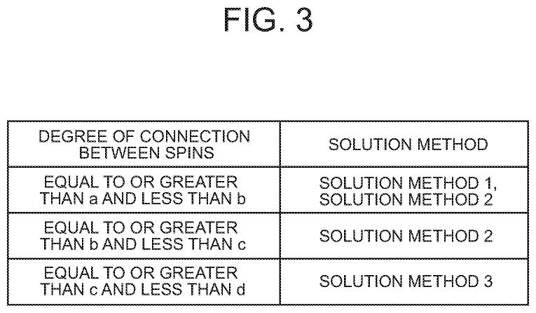

FIG. 2 is a schematic diagram showing each category of the degree of connection between spins and the solution method corresponding to each category. It is assumed that the solution method selection unit 3 retains the information illustrated in FIG. 2. In this case, the solution method selection unit 3 selects the “Solution Method 1” when the derived degree of connection between spins is equal to or greater than a and less than b, selects the “Solution Method 2” when the degree of connection between spins is equal to or greater than b and less than c, and selects the “Solution Method 3” when the degree of connection between spins is equal to or greater than c and less than d (see FIG. 2).

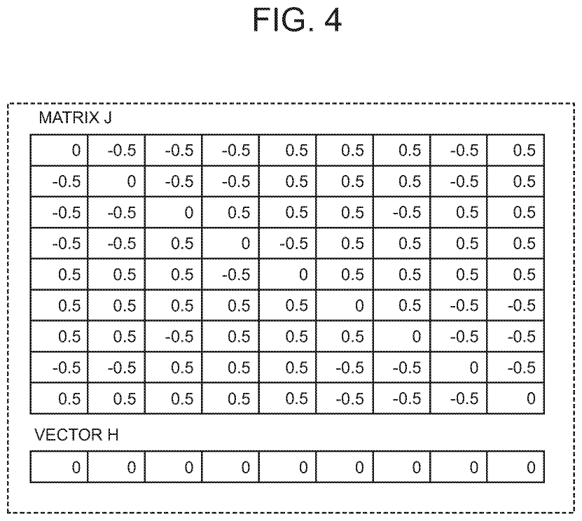

In addition, multiple solution methods may be corresponded to a category. FIG. 3 is a schematic diagram showing an example of a case in which there is a category to which multiple methods of solution solutions are corresponded. In the example shown in FIG. 3, two solution methods (the “Solution Method 1” and the “Solution Method 2”) are corresponded to the category “equal to or greater than a and less than b”. It is assumed that the solution method selection unit 3 retains the information illustrated in FIG. 3. In this case, the solution method selection unit 3 selects the “Solution Method 1” and the “Solution Method 2” when the derived degree of connection between spins is equal to or greater than a and less than b.

The solution method selection unit 3 may also select a solution method based on multiple types of feature information. In this case, the information in which a solution method is corresponded to a combination of categories defined for each feature information is predetermined, and the solution method selection unit 3 retains this information in advance. Then, the solution method selection unit 3 can select a solution method corresponding to the combination of categories to which each type of feature information belongs. There may be a case where multiple solution methods are corresponded to the combination of categories defined for each feature information, and the solution method selection unit 3 selects multiple solution methods.

The solution method selection unit 3 may also select a solution method based on feature information that is irrelevant to the scale of the combinatorial optimization problem and the required accuracy, and an index value that indicates the scale of the combinatorial optimization problem. An example of the index value indicating the scale of the combinatorial optimization problem is the number of spins specified from the input model (in this example, the Ising model) (hereinafter simply referred to as the number of spins). In this case, information in which a solution method is corresponded to a combination of the category of the number of spins and the category of the feature information is predetermined, and the solution method selection unit 3 retains this information in advance. Then, the solution method selection unit 3 can select the solution method corresponding to the combination of the category to which the number of spins belongs and the category to which the feature information belongs. There may be a case where multiple solution methods are corresponded to the combination of the category of the number of spins and the category of the feature information, and the solution method selection unit 3 selects multiple solution methods.

The solution method selection unit 3 generates selected solution method information, which is information indicating the selected solution method, and sends the selected solution method information to the solution request unit 4.

When the solution request unit 4 receives the selected solution method information, the solution request unit 4 recognizes the solution method indicated by the selected solution method information (i.e., the selected solution method). Then, the solution request unit 4 specifies a solution device that solves the combinatorial optimization problem using the selected solution method. The solution request unit 4 retains in advance information indicating the correspondence between each solution device and the solution method used by each solution device. Based on the information, the solution request unit 4 specifies a solution device that solves the combinatorial optimization problem using the selected solution method.

Then, the solution request unit 4 generates a solution request to be sent to the solution device corresponding to the selected solution method. The solution request is information that includes information that can specify the model (the Ising model or QUBO) used for solving the combinatorial optimization problem, and requests the solution device to solve the combinatorial optimization problem using the model (the Ising model or QUBO). The information that can specify the Ising model is the matrix J and the vector H. The information that can specify QUBO is the matrix Q.

In addition to information that can specify the model, the solution request unit 4 may also include parameters that are used to find a solution to the combinatorial optimization problem in the solution request. For example, when the solution device to which the solution request is sent uses a solution method that is broadly classified as simulated annealing, the initial temperature, the end temperature, and the temperature cooling rate may be included in the solution request as parameters. The solution request unit 4 may include parameters that are fixedly determined according to the solution device to which the solution request is sent in the solution request. The solution request unit 4 may determine the parameters according to guidelines provided by the vendor of the solution device to which the solution request is sent, or the solution request unit 4 may determine the parameters as fixed values depending on the size of the matrix J or the matrix Q. However, the method of determining parameters is not limited to the above examples.

The solution request may be information in a text or binary format. The solution request may also be information in the form of REST API (Representational State Transfer Application Programming Interface).

When the solution devices 61-65, which solve combinatorial optimization problems using different solution methods, are realized on the same computer as the solution method selection device 10, the solution request may be generated in the form of a system call or a function call to an application program or a library.

Although the model input to input unit 1 is the Ising model, there are cases in which the solution device to which the solution request is sent performs solution based on QUBO. In this case, the solution request unit 4 may convert the input Ising model to QUBO before generating a solution request. Conversely, there are cases where the model input to input unit 1 is QUBO, but the solution device to which the solution request is sent performs solution based on the Ising model. In this case, the solution request unit 4 may convert the input QUBO to the Ising model before generating a solution request. Whether each solution device performs solution based on the Ising model or based on QUBO can be stored in the solution request unit 4 in advance.

The solution request unit 4 sends the generated solution request to the destination solution device (in other words, the solution device corresponding to the selected solution method).

As mentioned above, there may be a case in which the solution method selection unit 3 selects multiple solution methods. In this case, the solution request unit 4 may specify a solution device and generate a solution request for each selected solution method, and send each solution request to its destination solution device.

Upon receiving a solution request, the solution device specifies a model (the Ising model or QUBO) based on information that can specify the model, and solves the combinatorial optimization problem based on the model. When a parameter is included in the solution request, the solution device also uses that parameter to find a solution. The solution device then sends the obtained solution of the combinatorial optimization problem to the solution method selection device 10.

The solution receiving unit 5 of the solution method selection device 10 receives the solution. As a result of the solution request unit 4 sending a solution request to multiple solution devices, it is possible that the solution receiving unit 5 receives a solution from each of the solution devices. In such a case, the user of the solution method selection device 10 may adopt each solution received by the solution receiving unit 5 as the solution to the combinatorial optimization problem. Alternatively, the user of the solution method selection device 10 may adopt only the solution with the best solution quality among the multiple solutions received by the solution receiving unit 5 as the solution to the combinatorial optimization problem.

The solution request unit 4 and the solution receiving unit 5 are realized, for example, by a CPU (Central Processing Unit) of a computer that operates according to a solution method selection program and a communication interface of the computer. In this case, the CPU may read the solution method selection program from a program recording medium such as a program storage device of the computer, and operate as the solution request unit 4 and the solution receiving unit 5 according to the program using the communication interface. The feature information derivation unit 2 and the solution method selection unit 3 can be realized, for example, by the CPU of the computer operating according to the solution method selection program. In this case, the CPU may read the solution method selection program from the program recording medium such as the program storage device of the computer as described above, and operate as the feature information derivation unit 2 and the solution method selection unit 3 according to the program.

Next, using the maximum cut problem and the traveling salesman problem as examples, it will be shown that there is a difference in the tendency of the feature information depending on the type of combinatorial optimization problem. Here, the case where the feature information is the degree of connection between spins is used as an example.

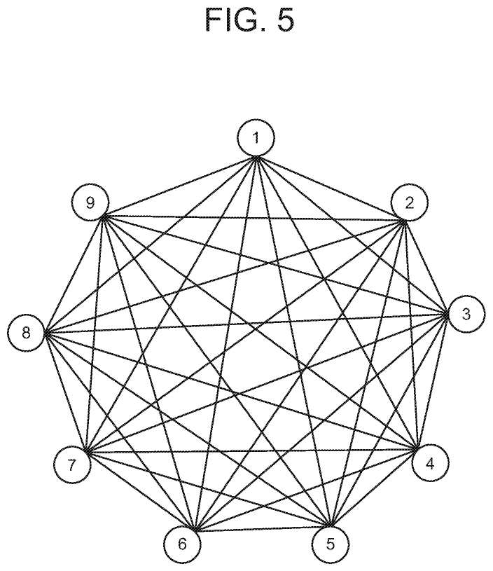

FIG. 4 is a schematic diagram showing an example of the matrix J and the vector H of the Ising model obtained based on the maximum cut problem. In this example, the case where the number of spins is 9 is shown. In matrix J, spin i and spin j are connected when the constant corresponding to the combination of spin i and spin j (an element of the matrix J) is non-zero, and spin i and spin j are not connected when the constant corresponding to the combination of spin i and spin j is zero. FIG. 5 is a schematic diagram showing the connection between spins corresponding to FIG. 4. In the examples shown in FIG. 4 and FIG. 5, the degree of connection between spins is 100%.

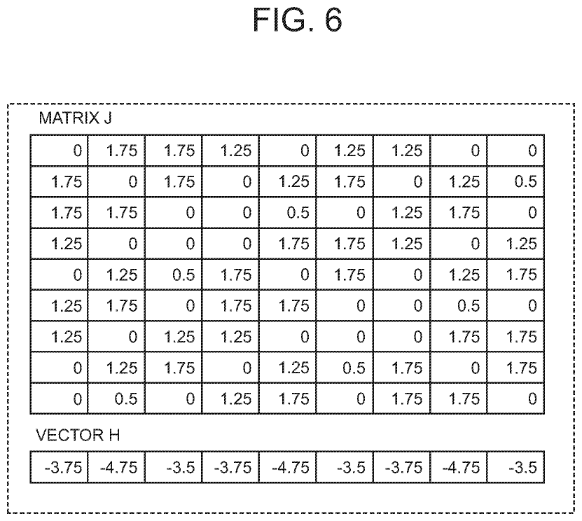

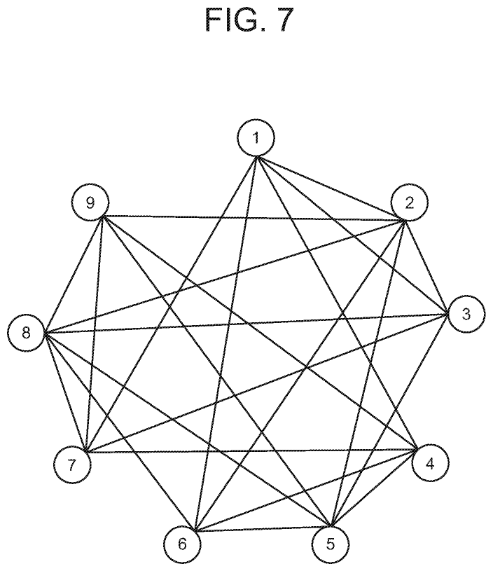

FIG. 6 is a schematic diagram showing an example of the matrix J and the vector H of the Ising model obtained based on the traveling salesman problem. This example also shows the case where the number of spins is 9. FIG. 7 is a schematic diagram showing the connection between spins corresponding to FIG. 6. In the examples shown in FIG. 6 and FIG. 7, the degree of connection between spins is about 67%.

From the above, it can be seen that when the degree of connection between spins is compared between the maximum cut problem and the traveling salesman problem, the degree of connection between spins in the maximum cut problem tends to be larger. Thus, there is a difference in the tendency of the feature information depending on the type of combinatorial optimization problem.

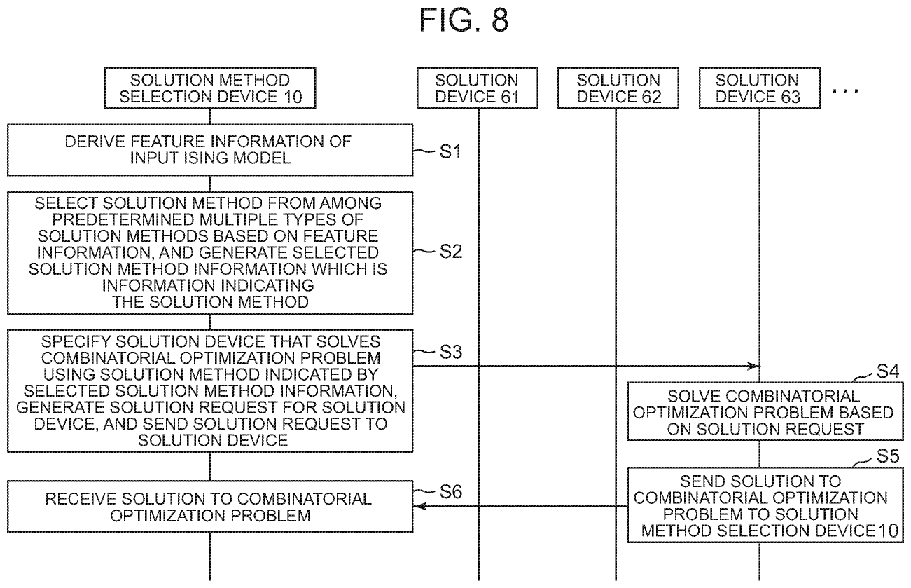

Next, the processing flow of the example embodiment of the present invention will be explained using specific examples. FIG. 8 is a sequence diagram showing an example of the processing flow of the solution method selection device 10 of the example embodiment of the present invention. Matters that have already been explained will be omitted as appropriate.

In the following example, the Ising model is input to the input unit 1.

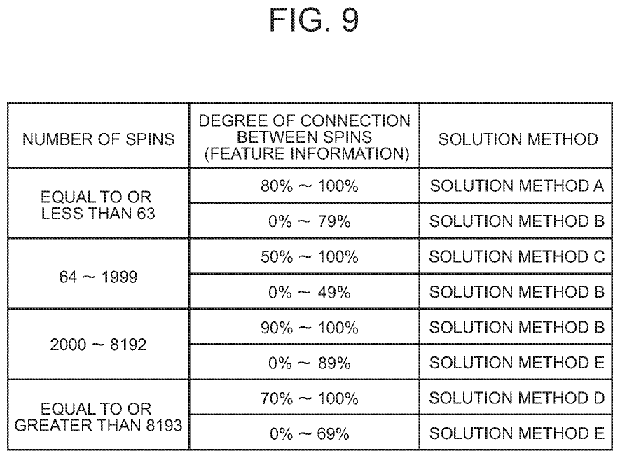

In the example shown below, it is assumed that information in which a solution method is corresponded to a combination of the category of the number of spins and the category of the feature information (in this example, the degree of connection between spins) is predetermined, and that the information is retained by the solution method selection unit 3 in advance. FIG. 9 is a schematic diagram showing an example of information in which a solution method is corresponded to a combination of the category of the number of spins and the category of the degree of connection between spins. In this example, the information shown in FIG. 9 is retained in advance in the solution method selection unit 3. In this example, the feature information derivation unit 2 derives the degree of connection between spins using “%” as the unit and rounding off to one decimal place.

The “Solution Method A” shown in FIG. 9, for example, is a solution method suitable for the case of small-scale fully connected and suitable for the maximum cut problem. In this example, it is assumed that the solution device 61 (see FIG. 1) uses the Solution Method A to solve the combinatorial optimization problem.

The “Solution Method B” shown in FIG. 9, for example, is a solution method suitable for the case of medium-scale sparsely connected and suitable for the maximum cut problem and the traveling salesman problem. In this example, it is assumed that the solution device 62 (see FIG. 1) uses the Solving Method B to solve the combinatorial optimization problem.

The “Solution Method C” shown in FIG. 9, for example, is a solution method suitable for the case of medium-scale fully connected and suitable for the maximum cut problem. In this example, it is assumed that the solution device 63 (see FIG. 1) uses the Solution Method C to solve the combinatorial optimization problem.

The “Solution Method D” shown in FIG. 9, for example, is a solution method suitable for the case of large-scale fully connected and suitable for the maximum cut problem. In this example, it is assumed that the solution device 64 (see FIG. 1) uses the Solution Method D to solve the combinatorial optimization problem.

The “Solution Method E” shown in FIG. 9, for example, is a solution method suitable for the case of large-scale sparsely connected and suitable for the maximum cut problem and the traveling salesman problem. In this example, it is assumed that the solution device 65 (see FIG. 1) uses the Solution Method E to solve the combinatorial optimization problem.

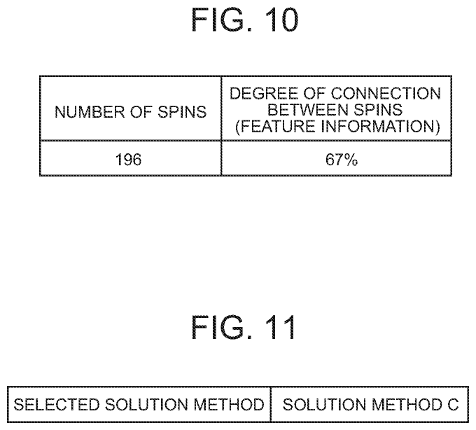

When the Ising model is input to the input unit 1, the feature information derivation unit 2 derives the feature information (in this example, the degree of connection between spins) of the input Ising model (step S1). In this example, as described above, the feature information derivation unit 2 derives the degree of connection between spins using “%” as the unit and rounding off to one decimal place. In this example, in step S1, the feature information derivation unit 2 also derives the number of spins based on the input Ising model. FIG. 10 is an explanatory diagram showing an example of the degree of connection between spins and the number of spins derived in step S1. In this example, it is assumed that the feature information derivation unit 2 derives “67%” as the degree of connection between spins and “196” as the number of spins.

Next, the solution method selection unit 3 selects a solution method from among predetermined multiple types of solution methods (in this example, the Solution Methods A to E; see FIG. 9) based on the feature information derived in step S1. Then, the solution method selection unit 3 generates the selected solution method information which is information indicating the solution method (step S2).

In this example, the solution method selection unit 3 refers to the information shown in FIG. 9 and selects the “Solution Method C” that corresponds to the combination of the category of the number of spins to which the number of spins “196” belongs and the category of the degree of connection between spins to which the degree of connection between spins “67%” belongs (see FIG. 9). Then, the solution method selection unit 3 generates the selected solution method information indicating the “Solution Method C” and sends the selected solution method information to the solution request unit 4. FIG. 11 is a schematic diagram showing an example of the selected solution method information.

The solution request unit 4 specifies a solution device that solves the combinatorial optimization problem using the solution method indicated by the selected solution method information, generates a solution request for the solution device, and sends the solution request to the solution device (step S3).

In this example, the solution device that solves the combinatorial optimization problem using the “Solution Method C” is the solution device 63. Therefore, the solution request unit 4 specifies the solution device 63 and generates the solution request for the solution device 63. The solution request unit 4 includes information that can specify the model in the solution request. The information that can specify the Ising model is the matrix J and the vector H. The information that can specify QUBO is the matrix Q. In this example, it is assumed that the solution device 63 performs solution based on the Ising model. The solution request unit 4 may also include in the solution request the parameters to be used in solving the combinatorial optimization problem. In the present invention, the method of determining the parameters is not limited.

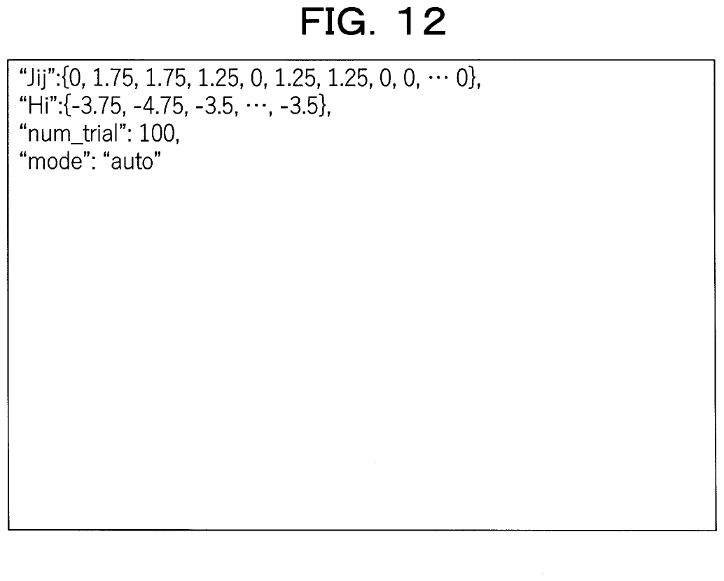

FIG. 12 is a schematic diagram showing an example of a solution request. The first line shown in FIG. 12 represents the matrix J. The second line shown in FIG. 12 represents the vector H. In other words, the first and second lines in FIG. 12 correspond to information that can specify the Ising model. The third line in FIG. 12 is a parameter representing the number of trials, and the fourth line in FIG. 12 is a parameter representing the trial mode.

FIG. 12 shows an example of a case in which the solution request is text-format information. As mentioned above, the solution request may be information in a text format, in a binary format, or in the form of REST API. When the solution devices 61-65 are realized on the same computer as the solution method selection device 10, the solution request may be generated in the form of a system call or a function call to an application program or a library.

In this example, the solution device 63 receives the solution request from the solution request unit 4. Then, based on the solution request, the solution device 63 solves the combinatorial optimization problem (step S4). For example, it is assumed that the solution device 63 receives the solution request as illustrated in FIG. 12. Then, the solution device 63 specifies the Ising model based on the first and the second lines shown in FIG. 12, and solves the combinatorial optimization problem using the Ising model and the parameters included in the solution request.

Then, the solution device 63 sends the solution obtained in step S4 (the solution to the combinatorial optimization problem) to the solution method selection device 10 (step S5).

The solution receiving unit 5 of the solution method selection device 10 receives the solution to the combinatorial optimization problem from the solution device 63 (step S6).

As mentioned above, there is a difference in the tendency of the feature information depending on the type of combinatorial optimization problem. According to the present example embodiment, given a model used to solve a combinatorial optimization problem, the feature information derivation unit 2 extracts the feature information representing the feature of the model. Then, the solution method selection unit 3 selects a solution method for the combinatorial optimization problem from among predetermined multiple types of solution methods based on the feature information. Thus, according to the present example embodiment, a solution method suitable for a given model can be selected from among predetermined multiple types of solution methods.

In the above example embodiment, a case in which the solution request unit 4 generates a solution request that includes information that can specify a model (the Ising model or QUBO) and sends the solution request to the destination solution device has been shown. It is also possible for the solution request unit 4 to generate a solution request that includes the model itself (the Ising model itself or QUBO itself) and send the solution request to the destination solution device. In other words, the solution request may be information that includes the model itself (the Ising model itself or the QUBO itself).

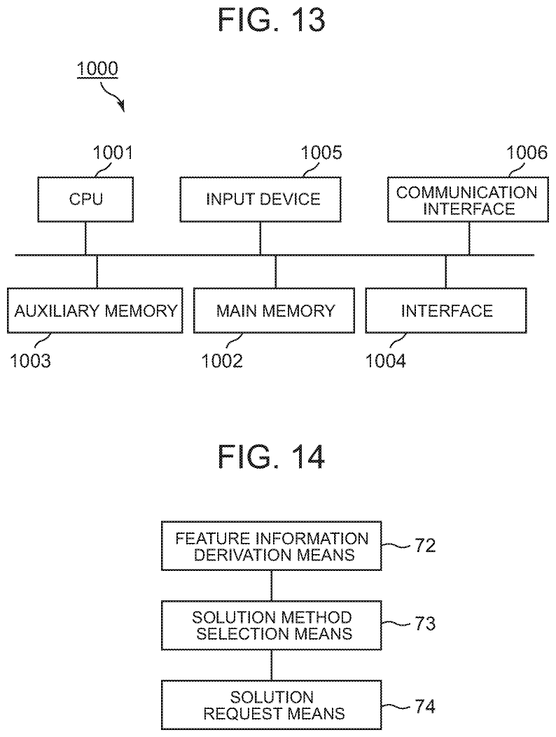

FIG. 13 is a schematic block diagram showing an example of computer configuration related to the solution method selection device of the example embodiment of the present invention. The computer 1000 includes a CPU 1001, a main memory 1002, an auxiliary memory 1003, an interface 1004, an input device 1005, and a communication interface 1006.

The solution method selection device 10 of the example embodiment of the present invention is realized by, for example, the computer 1000. The operation of the solution method selection device 10 is stored in the auxiliary memory 1003 in the form of a solution method selection program. The CPU 1001 reads the solution method selection program, expands the solution method selection program in the main memory 1002, and executes the process described in the above example embodiment according to the solution method selection program.

The auxiliary memory 1003 is an example of a non-transitory tangible medium. Other examples of non-transitory tangible media include magnetic disks connected via interface 1004, magneto-optical disks, CD-ROM (Compact Disk Read Only Memory), DVD-ROM (Digital Versatile Disk Read Only Memory), a semiconductor memory, etc. When the program is delivered to the computer 1000 through a communication line, the computer 1000 may expand the program in the main memory 1002 and execute the process described in the above example embodiment according to the program.

Some or all of the components may be realized by general-purpose or dedicated circuitry, processor, or a combination of these. These may comprise a single chip or multiple chips connected via a bus. Some or all of the components may be realized by a combination of the above-mentioned circuitry, etc. and a program.

When some or all of components are realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

Next, an overview of the present invention is described. FIG. 14 is a block diagram showing an overview of the solution method selection device of the present invention. The solution method selection device of the present invention includes feature information derivation means 72, solution method selection means 73, and solution request means 74.

The feature information derivation means 72 (e.g., the feature information derivation unit 2) derives feature information that represents a feature of a model (e.g., the Ising model or QUBO) used to solve a combinatorial optimization problem, when the model is given.

The solution method selection means 73 (e.g., the solution method selection unit 3) selects a solution method for the combinatorial optimization problem from among predetermined multiple types of solution methods based on the feature information.

The solution request means 74 (e.g., the solution request unit 4) send a solution request that includes information that can specify the model used to solve the combinatorial optimization problem to a solution device that solves the combinatorial optimization problem using the selected solution method.

According to such a configuration, given a model used for solving a combinatorial optimization problem, a solution method suitable for the given model can be selected from among predetermined multiple types of solution methods.

The solution method selection device may include solution receiving means (e.g., the solution receiving unit 5) for receiving a solution to the combinatorial optimization problem from the solution device to which the solution request was sent.

The feature information may be degree of connection between spins.

The feature information may be statistic of elements of a matrix (e.g., the matrix J or the matrix Q) that is specified from the given model.

The feature information may be an eigenvalue of a matrix (e.g., the matrix J or the matrix Q) that is specified from the given model.

Although the present invention has been described above with reference to the example embodiment, the present invention is not limited to the above example embodiment. Various changes can be made to the configuration and details of the present invention that can be understood by those skilled in the art within the scope of the present invention.

### INDUSTRIAL APPLICABILITY

The present invention is suitably applied to a solution method selection device that selects a solution method for a combinatorial optimization problem.

### REFERENCE SIGNS LIST

1 Input unit
2 Feature information derivation unit
3 Solution method selection unit
4 Solution request unit
5 Solution receiving unit
10 Solution method selection device
61-65 Solver

What is claimed is:

1. A solution method selection device comprising:
a memory configured to store instructions; and
a processor configured to execute the instructions to:
derive feature information that represents a feature of a model used to solve a combinatorial optimization problem, when the model is given;
select a solution method for the combinatorial optimization problem from among predetermined multiple types of solution methods based on the feature information; and
send a solution request that includes information that can specify the model used to solve the combinatorial optimization problem to a solution device that solves the combinatorial optimization problem using the selected solution method.

2. The solution method selection device according to claim 1,
wherein the processor receives a solution to the combinatorial optimization problem from the solution device to which the solution request was sent.

3. The solution method selection device according to claim 1,
wherein the feature information is degree of connection between spins.

4. The solution method selection device according to claim 1,
wherein the feature information is statistic of elements of a matrix that is specified from the given model.

5. The solution method selection device according to claim 1,
wherein the feature information is an eigenvalue of a matrix that is specified from the given model.

6. A solution method selection method, implemented by a computer, comprising:
deriving feature information that represents a feature of a model used to solve a combinatorial optimization problem, when the model is given;
selecting a solution method for the combinatorial optimization problem from among predetermined multiple types of solution methods based on the feature information; and
sending a solution request that includes information that can specify the model used to solve the combinatorial optimization problem to a solution device that solves the combinatorial optimization problem using the selected solution method.

7. The solution method selection method according to claim 6, further comprising:
receiving a solution to the combinatorial optimization problem from the solution device to which the solution request was sent.

8. A non-transitory computer-readable recording medium in which a solution method selection program is recorded, wherein the solution method selection program causes a computer to execute:
a feature information derivation process of deriving feature information that represents a feature of a model used to solve a combinatorial optimization problem, when the model is given;
a solution method selection process of selecting a solution method for the combinatorial optimization problem from among predetermined multiple types of solution methods based on the feature information; and
a solution request process of sending a solution request that includes information that can specify the model used to solve the combinatorial optimization problem to a solution device that solves the combinatorial optimization problem using the selected solution method.

9. The non-transitory computer-readable recording medium in which the solution method selection program is recorded, according to claim 8,
wherein the solution method selection program causes the computer to execute:
a solution receiving process of receiving a solution to the combinatorial optimization problem from the solution device to which the solution request was sent.
